(19) United States
(12) Patent Application Publication
(10) Pub. No.: US 2009/0175676 A1
(43) Pub. Date: Jul. 9, 2009

(54) DEVICE FOR CONNECTING TWO OR MORE ACTUATING CABLES

(76) Inventor: Eugene Ficyk, Livonia, MI (US)

Correspondence Address: KANG INTELLECTUAL PROPERTY LAW, LLC, 214 ELM STREET, SUITE 106, WASHINGTON, MO, 63090, US

(21) Appl. No.: 12/349,828

(22) Filed: Jan. 7, 2009

Related U.S. Application Data
(60) Provisional application No. 61/010,555, filed on Jan. 8, 2008.

(51) Int. Cl. F16C 11/00; F16C 1/10

(52) U.S. Cl. 403/123; 74/502.4

(57) ABSTRACT

This invention presents a device for connecting two or more actuating cables. The device includes a housing, within which a bullet mount of a core wire of a first cable receives an end bullet of a core wire of a second cable. The device also includes a biasing mechanism for biasing the core wire of the first cable and the core wire of the second cable away from each other so that the core wires can be kept tensioned so as to function as a single core wire.

### CROSS-REFERENCE TO RELATED APPLICATIONS

This application claims priority of provisional application No. 61/010,555 filed Jan. 8, 2008.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

The present invention relates generally to a device for connecting two or more actuating cables. Specifically, the present invention relates to a device for connecting two or more actuating cables for remotely opening vehicular trunk lids, fuel filler covers, and the like.

2. Related Art

Actuating cables have been used in a variety of applications. Examples include Bowden cables that are used for remotely actuating latch mechanisms of a vehicle trunk and the like. Actuating cables are also used for transmitting motion of vehicle transmissions or accelerators. In most cases, a single actuating cable, whether long or short, has been used for the remote actuation or motion transmission. However, under certain circumstances, an installation of a single Bowden cable can be unfeasible or a use of two or more actuating cables can be desirable.

### SUMMARY OF THE INVENTION

Accordingly, it is an object of the present invention to provide a reliable connector device for connecting two or more actuating cables. To achieve the above object, according to en embodiment of the present invention, there is provided a cable connector system for connecting two cables. The cable connector system includes a housing, in which a bullet mount at an end of a core wire of a first cable receives an end bullet of a core wire of a second cable. The cable connector system also includes a biasing mechanism for biasing the core wire of the first cable and the core wire of the second cable away from each other such that the core wires can be kept tensioned and function as a single core wire.

In a preferred embodiment, the housing is comprised of a first housing part and a second housing part. The first housing part and the second housing part are pivotably connected with each other such that the first housing part and the second housing part can pivot between a closed position and an opened position. Preferably, the first housing part has a locking mechanism and the second housing part has a locking mechanism such that the locking mechanism of the first housing part and the locking mechanism of the second housing part can be releaseably engaged with each other in the closed position.

In a preferred embodiment, the bullet mount has a bullet receiving hole for receiving the end bullet of the second cable therein and a slot for receiving a portion of the core wire of the second cable. Preferably, the bullet receiving hole has an opened end for allowing an entrance of the end bullet of the second cable into the bullet receiving hole. The bullet receiving hole further has an inner sloping surface sloping downwardly away from the first cable so that when the core wires are kept tensioned the end bullet can be prevented from accidentally escaping out of the bullet receiving hole.

In a preferred embodiment, the bullet mount has an outer sloping surface sloping downwardly away from the first cable so that when the bullet approached the bullet mount the bullet can ride up the sloping surface.

According to en embodiment of the present invention, there is provided an actuating cable assembly. The actuating cable assembly includes a first actuating cable having a core wire and a conduit and a second actuating cable having a core wire and a conduit. The actuating cable assembly also includes a connector housing, within which the core wires of the first and second actuating cables are connected with each other. The actuating cable assembly also includes a biasing mechanism. The first actuating cable has a bullet mount at a first end of the core wire of the first actuating cable, and the second actuating cable has an end bullet at a first end of the core wire of the second actuating cable. The bullet mount is adapted for receiving the end bullet within the connector housing. The biasing mechanism biases the core wires of the first and second actuating cables away from each other so that the core wires can be kept tensioned.

In a preferred embodiment, the connector housing has a first housing part and a second housing part pivotably connected with each other such that the first housing part and the second housing part can pivot between a closed position and an opened position. Preferably, the first housing part has a locking mechanism and the second housing part has a locking mechanism. The locking mechanism of the first housing part and the locking mechanism of the second housing part can be releaseably engaged with each other in the closed position.

In a preferred embodiment, the bullet mount has a bullet receiving hole for receiving the end bullet therein and a slot for receiving a portion of the core wire of the second actuating cable. Preferably, the bullet receiving hole has an opened end for allowing an entrance of the end bullet into the bullet receiving hole. The bullet receiving hole further has an inner sloping surface sloping downwardly away from the first actuating cable so that when the core wires are kept tensioned the end bullet can be prevented from accidentally escaping out of the bullet receiving hole.

In a preferred embodiment, the bullet mount has an outer sloping surface sloping downwardly away from the first actuating cable so that when the bullet approached the bullet mount the bullet can ride up the sloping surface.

In a preferred embodiment, the biasing mechanism is a spring.

In a preferred embodiment, the actuating cable assembly further includes a bias reducing mechanism for reducing the bias exerted by the biasing mechanism on the core wires of the first actuating cables and second actuating cables. Preferably, the bias reducing mechanism includes an engagement feature disposed in an inner surface of the first housing part. Preferably and additionally, the bias reducing mechanism further includes an expanded diameter portion that can engage with the engagement feature of the inner surface of the first housing part in the closed position. Preferably, the engagement feature has a plurality of circumferential grooves.

In a preferred embodiment, the first actuating cable and second actuating cable comprise Bowden cables. In a preferred embodiment, a second end of one of the first and actuating cables is attached to a latch mechanism and a second end of the other of the first and second actuating cables is attached to a remote actuator for remotely releasing the latch mechanism.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The above and other objects and features of the present invention will become apparent from the following description of preferred embodiments given in conjunction with the accompanying drawings, in which:

FIG. 1 schematically shows a partially cross-sectional view of an embodiment of the present invention in a partially cross-sectional view; and

FIG. 2 schematically shows an embodiment of the present invention in a side elevated view.

### DETAILED DESCRIPTION OF THE INVENTION

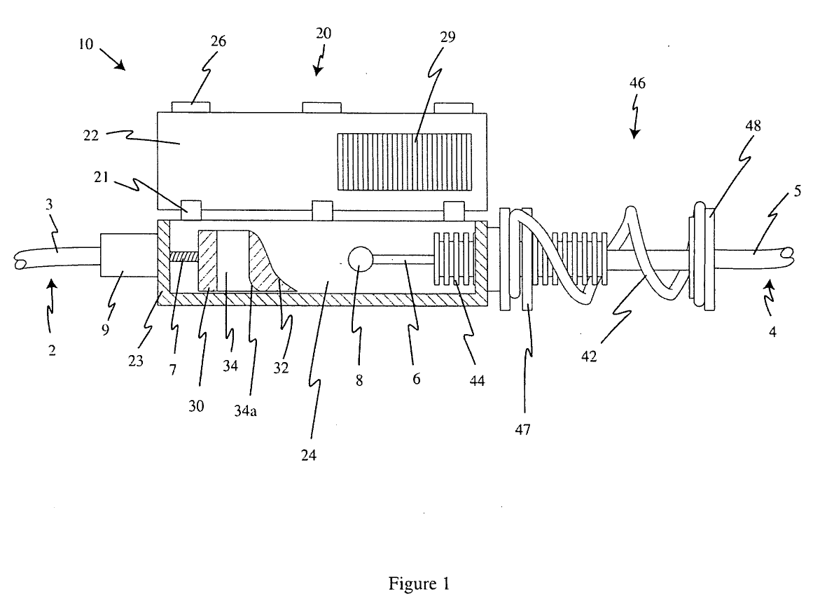

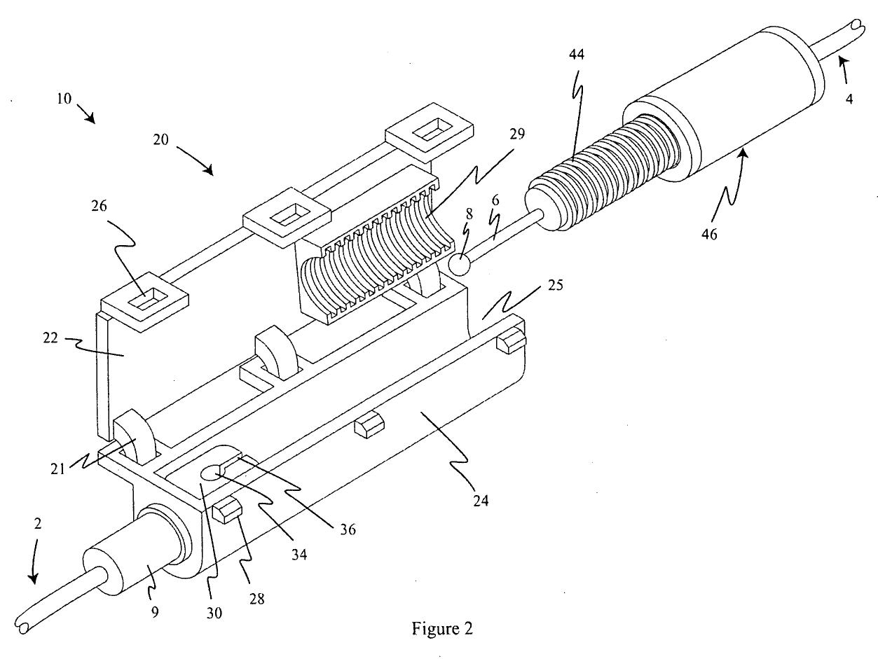

Turning now to the drawings, an embodiment of the present invention is shown. In FIGS. 1 and 2, the numeral 10 denotes a device for connecting a first actuating cable 2 and a second actuating cable 4 that can be used for remote control of a vehicular trunk lids, fuel filler covers, and the like.

In the illustrated embodiment, the device 10 has a generally cylindrical housing 20. The housing 20 includes an upper housing part 22 and a lower housing part 24, which are pivotably connected with each other through a hinge part 21. The upper housing part 22 and the lower housing part 24 can be pivoted between an opened position as shown in FIGS. 1 and 2 and a closed position (not shown). In the illustrated embodiment, the lower housing part 24 has an end wall 23 at its left end and an opened end 25 at the right end.

The upper housing part 22 has a locking mechanism 26 that corresponds to a locking mechanism 28 of the lower housing part 24 such that the locking mechanism 26 of the upper housing part 22 and the locking mechanism 28 of the lower housing part 24 can engage with each other when the upper housing part 22 and the lower housing part 24 are in the closed position. Preferably, the locking mechanisms 26, 28 can be releasably engaged with each other. Preferably, at least one of the two locking mechanisms 26,. 28 is made at least partially of resilient material so that engaging and/or disengaging of the locking mechanisms 26, 28 can be easily performed.

The first and second actuating cables 2 and 4 can be Bowden cables. The first actuating cable 2 has a core wire 7 and a conduit 3. The second actuating cable 4 also has a core wire 6 and a conduit 5. Where the present invention is used for a remote actuation of a latch mechanism of a vehicle trunk or the like, a left end (not shown) of the first actuating cable 2 may be attached to a lever mechanism (not shown) located close to a driver seat in a vehicle, and a right end (not shown) of the second actuating cable 4 may be attached to the latch mechanism (not shown) of the vehicle trunk or the like. Vice versa may also be possible, where the left end of the first actuating cable 2 can be attached to the latch mechanism and the right end of the second actuating cable 4 can be attached to the lever mechanism located close to the driver seat in the vehicle. In any case, by connecting the right end of the core wire 7 of the first actuating cable 2 and the left end of the core wire 6 of the second actuating cable 4, the device 10 can enable the first actuating cable 2 and the second actuating cable 4 to operate integrally as a single actuating cable.

In the illustrated embodiment, the second actuating cable 4 has an end bullet 8 at the left end of the core wire 6 for a connection with the right end of the core wire 7 of the first actuating cable 2. The end bullet 8 may be made integrally with the core wire 6. Alternatively, the end bullet 8 may be made separately and later fixedly attached to the left end of the core wire 6.

In the illustrated embodiment, fixedly attached to the right end of the core wire 7 of the first actuating cable 2 is a bullet mount 30 for receiving the end bullet 8 of the second actuating cable 4 for a connection of the core wires 6, 7. The bullet mount 30 has a bullet receiving hole 34 vertically extending from the top of the bullet mount 30. The bullet receiving hole 34 is bigger enough than the diameter of the end bullet 8 so that the end bullet 8 can fall into the bullet receiving hole 34 from the top of the bullet mount 30. Preferably, the bullet receiving hole 34 is deep enough to receive the entire end bullet 8 therein. In the illustrated embodiment, the bullet receiving hole 34 is opened from the top surface of the bullet mount 30.

The bullet mount 30 also has a slot 36 extending from the bullet receiving hole 34 through the right end of the bullet mount 30 such that when the end bullet 8 is placed in the bullet receiving hole 34, a portion of the core wire 6 of the second actuating cable 4 falls into the slot 36. Accordingly, in the illustrated embodiment, the slot 36 is opened from the top surface of the bullet mount 30. The width of the slot 36 must be bigger than the diameter of the core wire 7. However, the width of the slot 36 must be smaller than the diameter of the end bullet 8 so that the end bullet 8 cannot escape passing through the slot 36. In the illustrated embodiment, the bullet receiving hole 34 has a right inner surface 30a that slopes downwardly to the right side. After connected, the core wires 6, 7 are kept under tension within the housing 20 as described below, the end bullet 8 of the second actuating cable 4 is biased away from the bullet mount 30 (toward the right side in the drawings). Accordingly, the slope of the right inner surface 30a helps prevent the end bullet 8 from accidentally escaping out of the bullet receiving hole 34.

In the illustrated preferred embodiment, the bullet mount 30 has an outer sloping surface 32 sloping downwardly to the right side such that when the end bullet 8 of the second cable 4 approaches from the right to the left the end bullet 8 can ride up the outer sloping surface 32 so as to help easy assembly.

The core wire 7 of the first actuating cable 2 extends from the outside of the housing 20 into the housing 20, passing through a hole in the left end wall 23 of the housing 20. When a right end of the conduit 3 of the first actuating cable 2 sits on an outer surface of the left end wall 23 the right end of the conduit 3 is prevented from extending into the housing 20 passing through the left end wall 23. In the illustrated embodiment, the conduit 3 of the first actuating cable 2 has an expanded portion 9 sitting on the left end wall 23 of the housing 20. The right end or the expanded portion 9 of the conduit 3 may simply sit on the left end wall 23, or may be fixedly attached to the outer surface of the left end wall 23. Yet alternatively, the right end or the expanded portion 9 of the conduit 3 can be made integrally with the left end wall 23.

In the illustrated embodiment, the second actuating cable 4 has a biasing mechanism 46 for keeping the core wires 6, 7 connected under tension. Of course, a biasing mechanism can be disposed in the first actuating cable 2 instead. In the illustrated embodiment, the biasing mechanism 46 has a spring 42, a first spring mount 47 at its left end and a second spring mount 48 at its right end. The left end of the spring 42 is mounted on the circumference of the first spring mount 47 and the other end of the spring 42 is mounted on the circumference of the second spring mount 48. The first spring mount 47 has a circumferential groove for receiving the left end of the spring 42. The second spring mount 48 also has a circumferential groove for receiving the right end of the spring 42. Alternatively, the left end of the spring 42 can simply sit on the first spring mount 47 and the right end of the spring 42 can simply sit on the second spring mount 48. In either case, with the spring 42 compressed, the first spring mount 47 and the second spring mount 47 are biased away from each other.

In the illustrated embodiment, the conduit 5 of the second actuating cable 4 has an expanded diameter portion 44 at its left end. The expanded diameter portion 44 can be integrally made with the conduit 5 or can be separately made and fixedly attached to the left end of the conduit 5. In either case, the first spring mount 47 may slide over the expanded diameter portion 44. The second spring mount 48 is fixedly attached to conduit 5 and thus cannot be moved relative to the expanded diameter portion 44. Accordingly, the first spring mount 47 can be moved over the expanded diameter portion 44 toward the second spring mount 48 against the biasing force of the spring 42.

The first spring mount 47 is big enough so that the first spring mount 47 is prevented from entering the inside of the housing 20 through the opened end 25 of the lower housing 24. Thus, when the second spring mount 48 is manually pushed to the left against the biasing force applied by the spring 42, the end bullet 8 and the expanded diameter portion 44 can be moved toward the bullet mount 30 of the first actuating cable 2. This allows the end bullet 8 to come into contact with the sloping surface 32 of the bullet mount 30 and further to ride up the outer sloping surface 32.

Once the end bullet 8 of the second actuating cable 4 is received in the bullet receiving hole 34 and the manually applied pushing force is removed, the spring 42 biases the second spring mount 48 away from the first spring mount 47 sitting on the housing 20. Accordingly, the core wires 6, 7 can be kept tensioned and straightened within the housing 20.

In the illustrated embodiment, the upper housing part 22 has in its inner surface an engagement feature 29. The engagement feature 29 can engage with the expanded diameter portion 44 of the second actuating cable 4 when the upper housing part 22 and the lower housing part 24 are in a closed position. In the illustrated embodiment, the engagement feature 29 has a number of circumferential grooves and the expanded diameter portion 44 has a number of circumferential protrusions. Alternatively and/or additionally, the engagement feature 29 may have a number of circumferential protrusions and the expanded diameter portion 44 may have a number of circumferential grooves. The engagement between the engagement feature 29 of the housing 20 and the expanded diameter portion 44 of the conduit 5 of the second actuating cable 4 helps prevent the spring 42 from further biasing the first spring mount 47 and the second spring mount 48 away from each other. Accordingly, once the upper housing part 22 and the lower housing part 24 is in a closed position, the tensioning force between the core wires 6, 7 resulting from the spring 42 is significantly reduced, and thus a breaking of the end bullet 8 out of the core wire 6 can be avoided.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A cable connector system for connecting two cables, comprising:
a housing;
a bullet mount for attachment to an end of a core wire of a first cable, said bullet mount adapted for receiving an end bullet of a core wire of a second cable within said housing; and
a biasing mechanism for biasing the core wire of the first cable and the core wire of the second cable away from each other.

2. The cable connector system of claim 1, wherein said housing has a first housing part and a second housing part, said first housing part and said second housing part pivotably connected with each other such that said first housing part and said second housing part can pivot between a closed position and an opened position.

3. The cable connector system of claim 2, wherein said first housing part has a locking mechanism and said second housing part has a locking mechanism, said locking mechanism of said first housing part and said locking mechanism of said second housing part releaseably engageable with each other in said closed position.

4. The cable connector system of claim 1, wherein said bullet mount has a bullet receiving hole for receiving the end bullet of the second cable therein and a slot for receiving a portion of the core wire of the second cable.

5. The cable connector system of claim 4, wherein said bullet receiving hole has an opened end for allowing an entrance of the end bullet of the second cable into said bullet receiving hole, and wherein said bullet receiving hole further has an inner sloping surface sloping downwardly away from the first cable.

6. The cable connector system of claim 4, wherein said bullet mount has an outer sloping surface sloping downwardly away from the first cable.

7. An actuating cable assembly, comprising:
a first actuating cable having a core wire and a conduit;
a second actuating cable having a core wire and a conduit;
a connector housing; and
a biasing mechanism;
wherein said first actuating cable has a bullet mount at a first end of said core wire of said first actuating cable, and wherein said second actuating cable has an end bullet at a first end of said core wire of said second actuating cable, said bullet mount adapted for receiving said end bullet within said connector housing; and
wherein said biasing mechanism biases said core wire of said first actuating cable and said core wire of said second actuating cable away from each other.

8. The actuating cable assembly of claim 7, wherein said connector housing has a first housing part and a second housing part, said first housing part and said second housing part pivotably connected with each other such that said first housing part and said second housing part can pivot between a closed position and an opened position.

9. The actuating cable assembly of claim 8, wherein said first housing part has a locking mechanism and said second housing part has a locking mechanism, said locking mechanism of said first housing part and said locking mechanism of said second housing part releaseably engageable with each other in said closed position.

10. The actuating cable assembly of claim 7, wherein said bullet mount has a bullet receiving hole for receiving said end bullet therein and a slot for receiving a portion of said core wire of said second actuating cable.

11. The actuating cable assembly of claim 10, wherein said bullet receiving hole has an opened end for allowing an entrance of said end bullet into said bullet receiving hole, and wherein said bullet receiving hole further has an inner sloping surface sloping downwardly away from said first actuating cable.

12. The actuating cable assembly of claim 10, wherein said bullet mount has an outer sloping surface sloping downwardly away from said first actuating cable.

13. The actuating cable assembly of claim 7, wherein said biasing mechanism comprises a spring.

14. The actuating cable assembly of claim 7, further comprising a bias reducing mechanism for reducing the bias exerted by said biasing mechanism on said core wires of said first actuating cables and second actuating cables.

15. The actuating cable assembly of claim 14, wherein said bias reducing mechanism comprises an engagement feature disposed in an inner surface of said first housing part.

16. The actuating cable assembly of claim 15, wherein said bias reducing mechanism further comprises an expanded diameter portion engageable with said engagement feature in said closed position.

17. The actuating cable assembly of claim 15, wherein said engagement feature comprises a plurality of circumferential grooves.

18. The actuating cable assembly of claim 7, wherein said first actuating cable and second actuating cable comprise Bowden cables.

19. The actuating cable assembly of claim 18, wherein a second end of one of said first actuating cable and second actuating cable is attached to a latch mechanism and wherein a second end of the other of said first actuating cable and second actuating cable is attached to a remote actuator for remotely releasing the latch mechanism.
